(19) United States
(12) Patent Application Publication
(10) Pub. No.: US 2022/0083877 A1
(43) Pub. Date: Mar. 17, 2022

(54) PREDICTIVE DATA AGGREGATIONS FOR REAL-TIME DETECTION OF ANOMALOUS DATA

(71) Applicant: PAYPAL, INC., San Jose, CA (US)

(72) Inventors: Anupam Tarsauliya, Hyderabad (IN); Ayaz Ahmad, Hyderabad (IN); Ravi Shanker Sandepudi, Hyderabad (IN); Uttam Phalnikar, San Carlos, CA (US)

(21) Appl. No.: 17/115,650

(22) Filed: Dec. 8, 2020

(30) Foreign Application Priority Data
Sep. 11, 2020 (IN) 202021039401

(51) Int. Cl. G06N 5/04; G06N 20/00

(52) U.S. Cl. CPC G06N 5/04; G06N 20/00

(57) ABSTRACT

There are provided systems and methods for predictive data aggregations for real-time detection of anomalous data. A service provider, such as an electronic transaction processor for digital transactions, may access feature data for accounts prior to the feature data being used in a live risk analysis system, for example, at a designated time and/or for a designated time period. The service provider may predetermine data values from the feature data, such as aggregates of the feature data that are for certain time periods and utilized by the live risk analysis system. This processing may be done in a batch processing job in order to determine data values for multiple accounts. These data values are prestored in an available database for a distributed computing system of the service provider. Thereafter, when the live risk analysis system requires the data values, the data values may be immediately retrieved.

### CROSS-REFERENCE TO RELATED APPLICATION

The present application is a U.S. Nonprovisional Patent Application of and claims priority to Indian Provisional Patent Application No. 202021039401, filed Sep. 11, 2020, which is incorporated by reference herein in its entirety.

### TECHNICAL FIELD

The present application generally relates to real-time data processing in production computing environments and more particularly to determining data values prior to use in a risk analysis system and reducing data processing latency in such production computing environments.

### BACKGROUND

Users may utilize computing devices to access online domains and platforms to perform various computing operations and view available data. Generally, these operations are provided by different service providers, which may provide services for account establishment and access, messaging and communications, electronic transaction processing, and other types of available services. During use of these computing services, the processing platforms and services, the service provider may utilize risk analysis systems in real-time data processing to determine whether to proceed with certain operations, decline those operations, and/or require additional information to proceed with the operations. For example, an online transaction processor may process digital transactions electronically using one or more accounts for participants in the transaction. When processing transactions, the risk analysis and fraud detection systems may be used to determine whether to process the transaction. However, these risk analysis systems may require different data, which may be stored to offline or persistent databases and/or database systems that are not efficiently accessed. Thus, latency in fraud detection and risk decision-making may be caused by having to retrieve and access specific data from a large number of different data from the database systems in a production computing environment.

### BRIEF DESCRIPTION OF THE DRAWINGS

FIG. 1 is a block diagram of a networked system suitable for implementing the processes described herein, according to an embodiment;

FIG. 2 is an exemplary system environment where feature data is generated, stored, and processed to generate data aggregations and other data values for real-time detection of anomalous data, according to an embodiment;

FIG. 3 is an exemplary diagram of data processing interactions to determine data values to reduce latency in data retrieval and processing, according to an embodiment;

FIG. 4 is a flowchart of an exemplary process for predictive data aggregations for real-time detection of anomalous data, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for predictive data aggregations for real-time detection of anomalous data. Systems suitable for practicing methods of the present disclosure are also provided.

A service provider may provide different computing resources and services to users through different websites, resident applications (e.g., which may reside locally on a computing device), and/or other online platforms. When utilising the services of a particular service provider, the service provider may utilize real-time anomaly detection (e.g., risk analysis and/or fraud detection), which may be used for intelligent decision-making to reduce risk, fraud, and other anomalies. For example, an online transaction processor may provide services associated with electronic transaction processing, including account services, user authentication and verification, digital payments, risk analysis and compliance, and the like. These services may require risk analysis systems that operate within a production computing environment to process production data (e.g., transaction data and the like) and determine a risk or fraud analysis, score, or decision. The risk analysis may then be used to approve, decline, or otherwise process the transaction, an authentication, or another service of the online transaction processor. However, these risk services require different feature data, such as features of one or more accounts, transactions, users, and/or devices, which may be stored to persistent databases that introduce latency. To address this, the service provider, in different embodiments, may utilize a data aggregation engine that pre-calculates and predetermines one or more data values and/or aggregations, which may be stored to a distributed computing system. This aggregation engine and data values may be retrieved for the risk engine in a faster and more efficient manner in order to reduce latency normally incurred by using the persistent databases to retrieve feature data and determine these data values and aggregations.

For example, a service provider, such as an online transaction processor, may provide services to users, including electronic transaction processing through an online transaction processor (e.g., PayPal®) that allows merchants, users, and other entities to process transactions, provide payments, and/or transfer funds between these users. When interacting with the service provider, the user may process a particular transaction to provide a payment to another user or a third-party for items or services. Moreover, the user may view one or more digital accounts and/or digital wallets, including a transaction history and other payment information associated with the user's payment instruments and/or digital wallet. The user may also interact with the service provider to establish an account and other information for the user. In further embodiments, other service providers may also provide computing services, including social networking, microblogging, media sharing, messaging, business and consumer platforms, etc. These computing services may be deployed across multiple different applications including different applications for different operating systems and/or device types. Furthermore, these services may utilize the aforementioned risk analysis and fraud detection services, which may utilize predetermined data values to reduce latency in data processing.

In various embodiments, in order to utilize the computing services of a service provider, an account with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including payment card (e.g., credit/debit card) information, bank account information, gift card information, benefits/incentives, and/or financial investments, which may be used to process transactions after identity confirmation, as well as purchase or subscribe to services of the service provider. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services. Access and use of these accounts may generate account feature data, which may include different features for the account, transactions processed using the account, other online or digital actions and operations performed using the account, devices used to access and/or use the account, and additional user information.

In this regard, the service provider may receive and/or access data for one or more accounts, such as when data for an account is generated and/or entered to the service provider's systems. This data may include features associated with the account and/or actions and activities performed using the account, such as authentication, electronic transaction processing, account or user verification, and the like. Thus, the feature data may include one or more pieces or features of account data, device data, user data, transaction data, and the like, which may be utilized in a risk analysis, fraud detection, and/or compliance system for decision-making in production computing environments. For example, feature data for an account and/or user may correspond to an account number, username, user information, user/account identifier, and the like. Feature data for a transaction may include a transaction amount, time, merchant, items in the transaction, payment instrument, and the like. Feature data for a device may include information for a device used to access or use the account and/or process transactions, such as an IP address, MAC address, device fingerprint, operating system information, and the like. The service provider may store this data to a persistent database, which may incur latency when retrieving and processing the data in real-time for a data processing request, such as when an account is used for electronic transaction processing. Thus, the service provider may access the feature data prior to the data being required for a risk analysis or fraud detection engine or system, where the feature data may be locally stored to a cache or other available storage. This may be done in an offline process with a distributed set of machines. The service provider may also store the feature data to the accessible storage when generated and/or entered to the service provider's system for preprocessing and data aggregation.

Once the feature data is accessed and/or received, the service provider may then preprocess the data to generate predetermined data values and/or aggregations. These data values may correspond to data aggregations, averages (e.g., of transaction amounts), sums, maximum, percentile, means, medians, or the like for certain data features. For example, the data values may include a number of transactions processed using the account, account balances and/or balance adjustments, and/or other data features or points for the account may be processed to calculate these values and other data aggregations. Moreover, these data values may be determined for certain time periods, such as over a 7-day period, a 30-day period, or other time period selected by the service provider for use with the risk analysis systems (e.g., 24-hours, 60-day, 180-day, etc.). For example, a particular data aggregation may correspond to the number of transactions processed in the last X days from an IP address or device identifier, which may further be processed to determine an average value or percentile of accounts. These data values may be calculated and predetermined for a specific account, which may then be associated with the account through use of one or more identifiers (e.g., an account identifier) so that the data values may later be retrieved for the account. Determination of the data values may be done through the distributed computing system of distributed machines in order to more efficiently and quickly process the data through multiple machines.

In order to provide efficient processing of the feature data to determine data aggregations and values for features and other data of an account, the service provider may utilize batch data processing through one or more batch processing jobs. In this regard, the feature data may be accrued for multiple accounts and/or for multiple time periods required for data values used by the risk analysis system. This may be done for a specific time cycle and/or specific time at which the batch processing job is performed and processed by the service provider server. For example, the batch processing job may be designated for execution at a certain time of day, week, or month, as needed for the data values used by the risk analysis system. Once the feature data of multiple accounts is accessed or received for the batch processing job, the batch processing job may be used to determine the data values and aggregations when processed by the system. Thereafter, the data values and aggregations may be determined and stored in a distributed computing system for the service provider, which makes the data values available in a feature storage that is available to the risk analysis and/or fraud detection systems. This allows the data values to be efficiently accessed and used by the service provider independent of accessing the feature data from the persistent storage and processing the data to determine the required data values or aggregations.

Thereafter, at a future time, the service provider may receive a request to perform some action using the user's account and/or services of the service provider. This may include electronic transaction processing, authentication, user/account verification, and/or other action that requires a risk and/or fraud analysis by the service provider. The service provider may then pull one or more of the predetermined data values and/or aggregations that are required for the risk analysis. The service provider may determine which data values are needed and may fetch and retrieve those data values from the feature storage of the distributed computing system. This may be done without and independent of accessing the feature data from the persistent storage in order to reduce latency and provide more efficient data retrieval and processing. Moreover, by pre-calculating and determining the data values prior to use by the service provider's risk analysis systems, redundancy may be added so that if an error occurs in real-time and/or in the production computing environment (e.g., due to a system failure, timeout, computing attack, or the like), the data values may still be used (e.g., without having to access the persistent storage and calculate the values). Once the risk analysis is performed, a result of the risk analysis may be returned and used for processing the user's data processing request.

Moreover, over time, the feature data may change. Thus, the service provider may perform further batch processing jobs at certain time cycles or intervals in order to determine updated data values and/or aggregations. Once updated, the data values may be updated with the distributed computing system so that new data values may be used by the risk analysis and fraud detection systems of the service provider. The data values may also be used to test different machine learning systems and/or provide mimicked simulations of the aggregated features and data in an offline environment (e.g., to train different machine learning models and/or test trained machine learning models). The data values may be used for data validation in order to provide better accuracy of the machine learning models prior to deployment of the machine learning models in a production computing environment. The machine learning models may be used, in some embodiments, with the risk analysis systems, which may allow the data values to be used to train and test different intelligent models for risk analysis and fraud detection.

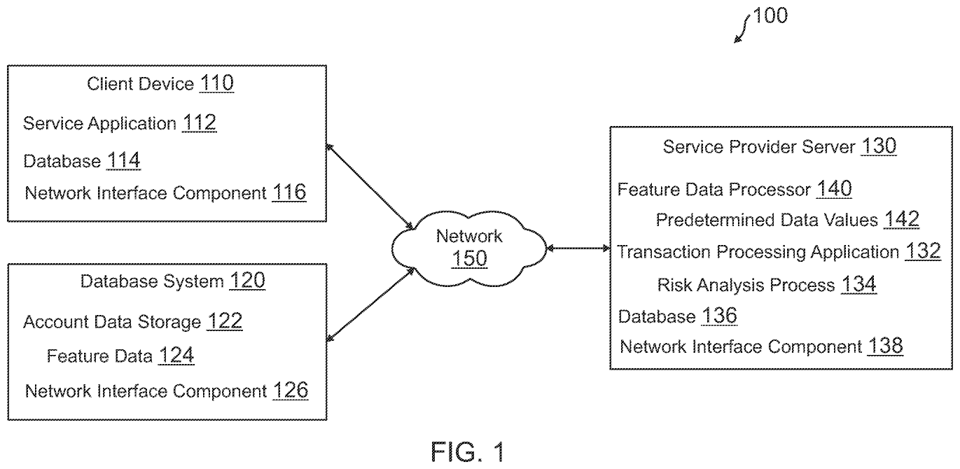

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a client device 110, a database system 120, and a service provider server 130 in communication over a network 150. Client device 110 may be utilized by a user to access a computing service or resource provided by service provider server 130, where service provider server 130 may provide various data, operations, and other functions to client device 110 via network 150 including those associated with risk analysis and/or fraud detection during use of services. In this regard, client device 110 may be used to generate feature data, which may be stored to database system 120. Service provider server 130 may access database system 120 to generate a batch processing job of the feature data, which may then be used to predetermine data values and feature aggregations for use by the risk analysis and/or fraud detection systems of service provider server 130.

Client device 110, database system 120, and service provider server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Client device 110 may be implemented as a communication device that may utilize appropriate hardware and software configured for wired and/or wireless communication with database system 120 and/or service provider server 130. For example, in one embodiment, client device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 contains a service application 112, a database 114, and a network interface component 116. Service application 112 may correspond to executable processes, procedures, and/or applications with associated hardware. In other embodiments, client device 110 may include additional or different modules having specialized hardware and/or software as required.

Service application 112 may correspond to one or more processes to execute modules and associated components of client device 110 to interact with a service provider or other online entity that may provide account services, resources, and services that may include one or more intelligent decision services for decision-making based on feature data, such as service provider server 130. In this regard, service application 112 may correspond to specialized hardware and/or software utilized by client device 110 to establish an account and utilize the account, which may include generating account, user, device, transaction, and other feature data associated with the account. Service application 112 may be used to register and access an account, such as by providing user personal and/or financial information, setting authentication information, queries, and challenges, and maintaining the account by providing other necessary information for account usage and/or verification. In this regard, with a transaction processor system, service application 112 may be used, during electronic transaction processing, to utilize user financial information, such as credit card data, bank account data, or other funding source data, as a payment instrument associated with the account for electronic transaction processing of a transaction. For example, service application 112 may utilize a digital wallet associated with the account as the payment instrument, for example, through accessing a digital wallet or account of a user through entry of authentication credentials and/or by providing a data token that allows for processing using the account. Service application 112 may also be used to receive a receipt or other information based on transaction processing. However, in other embodiments, service application 112 and the account may be used for other types of services, such as messaging, email, social networking or media, media sharing, microblogging, and/or other online activities.

Service application 112 may correspond to a general browser application configured to retrieve, present, and communicate information over the Internet (e.g., utilize resources on the World Wide Web) or a private network. For example, service application 112 may provide a web browser, which may send and receive information over network 140, including retrieving website information, presenting the website information to the user, and/or communicating information to the website. However, in other embodiments, service application 112 may include a dedicated application of service provider server 130 or other entity (e.g., payment provider, merchant, etc.), which may be configured to provide services through the application. Service application 112 may therefore be used to utilize account and service provider services provided by service provider server 130. In this regard, while utilising the services and data processing features of service provider server 130, feature data may be generated and/or accessed, where the feature data may be associated with account, user, device, transaction and/or other data having one or more features. Service provider server 130 may preprocess the features from this data to determine one or more predetermined data values and/or aggregations. These data values and/or aggregations may be used during intelligent decision-making by the artificial intelligence (AI) models and systems, such as machine learning (ML) and neural network (NN) models and systems. These may include risk analysis and/or fraud detection systems, such as electronic transaction processing systems. Thereafter, results of the data processing may be provided to the user via service application 112.

Client device 110 may further include database 114 stored on a transitory and/or non-transitory memory of client device 110, which may store various applications and data and be utilized during execution of various modules of client device 110. Database 114 may include, for example, identifiers such as operating system registry entries, cookies associated with service application 112 and/or other applications 114, identifiers associated with hardware of client device 110, or other appropriate identifiers, such as identifiers used for payment/user/device authentication or identification, which may be communicated as identifying the user/client device 110 to service provider server 130. Moreover, database 114 may include feature data, which may be provided during use of service provider server 130 and/or stored to database system 120 for predetermining data values and aggregations by service provider server 130.

Client device 110 includes at least one network interface component 116 adapted to communicate with database system 120 and/or service provider server 130. In various embodiments, network interface component 116 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Database system 120 may be maintained, for example, by a database and storage service provider, which may provide storage services across one or more computing devices and storage resources. In this regard, database system 120 includes one or more processing applications and database resources which may be configured to interact with client device 110 and service provider server 130 to store data generated during use of services and data processing features provided by service provider server 130. This may include feature data corresponding to one or more features associated with account, user, device, transaction, and/or other data. In certain embodiments, database system 120 may correspond to offline database storage configured to store and process big data (e.g., large and complex database sets). However, in other embodiments, database system 120 may correspond to a remote online system of computing resources, including cloud computing architectures, that provide distributed storage and processing of big data, such as those provided via APACHE HADOOP®. For example, database system 120 may be maintained by or include another type of service provider.

Database system 120 of FIG. 1 includes an account data storage 122, and a network interface component 126. Account data storage 122 may correspond to resources and/or applications with associated hardware for storage of data. In other embodiments, database system 120 may include additional or different modules having specialized hardware and/or software as required.

Account data storage 122 may correspond to one or more processes to execute modules and associated specialized hardware of database system 120 to store data received from service provider server 130, such as feature data 124 corresponding to big data having features associated with users, accounts, devices, data service usage including electronic transaction processing, and the like. Account data storage 122 may store feature data 124 having various identifiers associated with client device 110 and corresponding accounts used by client device 110, as well as other computing devices and accounts. Feature data 124 may also store account data, including payment instruments and authentication credentials, as well as transaction processing histories and data for processed transactions. Account data storage 122 may store financial information and tokenization data. Account data storage 122 may further store data necessary for intelligent decision-making through one or more AI models and systems, such as risk analysis systems, fraud detection systems, and the like.

In various embodiments, database system 120 includes at least one network interface component 126 adapted to communicate client device 110 and service provider server 130 over network 150. In various embodiments, network interface component 126 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Service provider server 130 may be maintained, for example, by an online service provider, which may provide services that use automated decision-making in an intelligent system when providing services to users and devices, such as client device 110. In this regard, service provider server 130 includes one or more processing applications which may be configured to interact with client device 110 to provide computing services including electronic transaction processing to users. In one example, service provider server 130 may be provided by PAYPAL®, Inc. of San Jose, Calif., USA. However, in other embodiments, service provider server 130 may be maintained by or include another type of service provider.

Service provider server 130 of FIG. 1 includes a feature data processor 140, a transaction processing application 132, a database 136, and a network interface component 138. Feature data processor 140 and transaction processing application 132 may correspond to executable processes, procedures, and/or applications with associated hardware. In other embodiments, service provider server 130 may include additional or different modules having specialized hardware and/or software as required.

Feature data processor 140 may correspond to one or more processes to execute modules and associated specialized hardware of service provider server 130 to predetermine feature data values and feature aggregates for one or more accounts for use by transaction processing application 132 when performing intelligent decision-making, such as when performing a risk analysis to approve or decline a requested action or operation. In this regard, feature data processor 140 may correspond to specialized hardware and/or software used by service provider server 130 to first receive and/or access feature data corresponding to account, user, device, transaction, and/or other data from one or more offline or remote database storages, such as feature data 124 from database system 120. This data includes features that may be aggregated to determine data values and data aggregations, such as an aggregated transaction amount for transactions requested and processed by an account over one or more time periods, number of transactions over the time period(s), transaction types over the time period(s), account access/usages over the time period(s), devices used over the time period(s), and other data that may be aggregated and calculated to determine aggregations, averages, sums, maximum, percentile, means, medians, or the like for the features in feature data 124.

Feature data 124 may be accessed and/or received over time and/or in a thread or processing job that executes to retrieve feature data 124 at a certain time or during a time cycle for calculating predetermined data values 142. This may be designated by service provider server 130 for when predetermined data values 142 should be calculated and/or updated based on new data and/or changes to feature data 124. Feature data 124 may be designated for one or more accounts, including multiple accounts that may each have a processing job to determine corresponding ones of predetermined data values 142 for the data values and/or aggregations of features for each account. Feature data 124 may be accessed and/or received prior to being required for data processing, such as by transaction processing application 132 in a risk analysis. Thus, latency in accessing feature data 124 may not affect the intelligent decision-making systems and services of service provider server 130.

Once feature data 124 is accessed and/or received, feature data processor 140 may then generate one or more batch processing jobs, which may be used to process the features for each corresponding account from feature data 124. Thereafter feature data processor 140 may process the batch processing job(s) to determine predetermined data values 142. Once generated and determined, predetermined data values 142 may be stored within a distributed computing environment provided by service provider server 130, such as within one or more databases corresponding to database 136. Predetermined data values 142 may then be fetched and used by intelligent decision services of service provider server 130, such as those used by transaction processing application 132. Thus, real-time anomaly detection (e.g., risk analysis and/or fraud detection) may not incur the latency in asking feature data 124 during real-time decision-making and data processing.

Transaction processing application 132 may correspond to one or more processes to execute modules and associated specialized hardware of service provider server 130 to process a transaction, which may be assisted by risk analysis process 134 for anomaly detection and other decision-making during use of the services of transaction processing application 132. In this regard, transaction processing application 132 may correspond to specialized hardware and/or software used by a user associated with client device 110 to establish a payment account and/or digital wallet, which may be used to generate and provide user data for the user, as well as process transactions. In various embodiments, financial information may be stored to the account, such as account/card numbers and information. A digital token for the account/wallet may be used to send and process payments, for example, through an interface provided by service provider server 130. In some embodiments, the financial information may also be used to establish a payment account. Further, after establishment of the account, the account may be used with the various services provided by service provider server 130. These actions and operations may be used to generate features, stored as feature data 124 and used to calculate predetermined data values 142.

The payment account may be accessed and/or used through a browser application and/or dedicated payment application executed by client device 110 and engage in transaction processing through transaction processing application 132, such as service application 112 that displays UIs from service provider server 130. Transaction processing application 132 may process the payment and may provide a transaction history to client device 110 for transaction authorization, approval, or denial. Such account services, account setup, authentication, electronic transaction processing, and other services of transaction processing application 132 may utilize risk analysis process 134, such as for anomaly detection, risk analysis, fraud detection, and the like. Risk analysis process 134 may implement anomaly detection using predetermined data values 142, for example, based on date values and aggregations determined from feature data 124. This allows for performing intelligent decision-making and anomaly detection without being required to access feature data 124 from offline and/or remote storage by database system 120, which incurs latency and efficiency issues in data retrieval and processing.

Additionally, service provider server 130 includes database 136. Database 136 may store various identifiers associated with client device 110. Database 136 may also store account data, including payment instruments and authentication credentials, as well as transaction processing histories and data for processed transactions. Database 136 may store financial information and tokenization data. Such data may be initially stored locally, such as in a data cache for processing, and/or transmitted to database system 120 for storage. Database 136 may further store data necessary for feature data processor 140, including data retrieved from database system 120 for use during batch processing. Additionally, batch processing jobs and results of those jobs, such as data values and aggregates determine from feature data for one or more accounts, may be stored to database 136.

In various embodiments, service provider server 130 includes at least one network interface component 138 adapted to communicate client device 110 and/or database system 120 over network 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

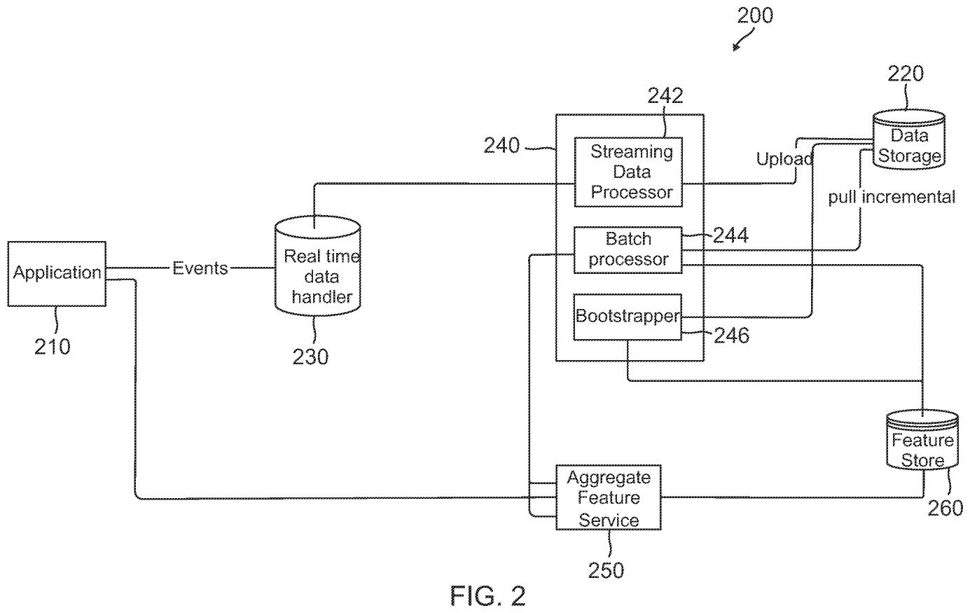

FIG. 2 is an exemplary system environment 200 where feature data is generated, stored, and processed to generate data aggregations and other data values for real-time detection of anomalous data, according to an embodiment. System environment 200 of FIG. 2 includes an architecture of different components, databases, applications, and the like used by feature data processor 140 discussed in reference to system 100 of FIG. 1. In this regard, an application 210 of client device 110 may request operations, navigate between UIs and data, and otherwise interact with service provider server 130 for generating feature data and providing anomaly detection using predictive data aggregations, where client device 110 and service provider server 130 are discussed with respect to system 100.

System environment 200 shows how feature data processor 140 may be used to provide predictive data aggregations and other data values calculated from feature data for one or more accounts, which may be used with application 210. Initially, application 210 may be used to perform events with the corresponding service provider (e.g., service provider server 130). Events may correspond to uses of services and other interactions that application 210 may perform with the service provider, including using an account for electronic transaction processing. These events may be received and processed by a real-time data handler 230, such as APACHE KAFKA®, which may provide computing services to handle real-time data from the events performed by application 210 with the service provider. Thereafter, real-time data handler 230 may provide the data to a streaming data processor 242 of a predictive data aggregation engine 240 for the service provider. Streaming data processor 242 may provide an interface and operations, for example through one or more application programming interfaces (APIs) and corresponding API calls and interactions, with a data storage 220.

When the events occur from the interactions and operations performed by application 210, real-time data handler 230 interfaces with streaming data processor 242 to have data for the events stored to data storage 220. The events for the data may correspond to feature data, such as features associated with the account, user, device, transaction, and the like that are associated with the events. Data storage 220 may correspond to an offline and/or remote data storage, such as a big data handler and storage for large amounts of data resulting from the events performed by application 210, as well as events from other applications and devices interacting with the service provider. Data storage 220 may store big data from electronic transaction processing and other interactions performed by users, merchants, and other entities with the service provider. Data storage 220 may store the data from streaming data processor 242 over time, which may include database tables having identifiers and data corresponding to the different events.

Thereafter, in order to provide predictive data aggregations and other predetermined data values, data aggregation engine 240 may incrementally pull feature data from data storage 220 in one or more processing jobs or data retrieval threads. Pulling of the feature data for the events corresponding to the different accounts and interactions may occur over time and prior to the service provider requiring the data for anomaly detection or other risk analysis and/or intelligent decision-making. Pulling of the data may be performed by a batch processor 244 of data aggregation engine. Batch processor 244 may pull the data incrementally to create processing jobs for a batch processing job. Batch processor 244 may generate a batch processing job from the feature data, where the batch processing job includes multiple processing jobs for processing together in a batch by the systems of the service processor. Pulling of the feature data may therefore correspond to the different accounts and data designated for the batch processing job by the different processing threads and jobs within the batch processing job.

Once the batch processing job is determined, batch processor 244 may provide the batch processing job to aggregate feature service 250, which may perform processing of the batch processing job for feature data corresponding to multiple accounts. Aggregate feature service 250 may determine predictive data aggregates and other predetermined data values for the accounts and corresponding feature data in the batch processing job. The predictive data aggregates and data values may correspond for one or more of a data aggregation, average, sum, maximum, percentile, mean, median, or the like for certain data feature of each account and corresponding feature data in the batch processing job. Moreover, these aggregates and data values may correspond to one or more time periods, such as a last 7-day time period, last 30-day time period, a designated month or time of the year, and the like. For example, an aggregation, sum, median, mean, or the like may be calculated for a particular feature corresponding to an account for the last 7 days, last 30 days, and the like. Once determined, aggregate feature service 250 may store these data aggregations and other predetermined data values to a feature store 260 for future use. Feature store 260 may be accessible and utilized within a distributed computing system and environment of the service provider, which may provide faster access and retrieval of the data to reduce the latency in retrieving feature data from data storage 220.

Thereafter, when the service provider requires one or more of the data aggregations and/or other data values for use in an intelligent decision-making system, such as an anomaly detection or risk analysis system, the data aggregation(s)/value(s) may be retrieved instead from feature store 260 of the distributed computing system. A user may perform another interaction with the service provider, which may correspond to a future event after determination of the predictive data aggregations and other predetermined data values. This may include an anomalous data detector or other intelligent decision service that requires a data aggregation or other data value to determine some decision, such as whether a transaction indicates fraud and/or should be approved/declined. Aggregate feature service 250 may then access feature store 260 to retrieve one or more of the data aggregations, which may be provided to the intelligent engine for use with determining a decision and/or providing some output. Thus, data storage 220 is not required to be accessed and latency in decision-making may be reduced.

A bootstrapper 246 may also be used to automate the processes and features for feature data pulling, batch processing job generation, data aggregation determination, and/or data aggregation retrieval of data aggregation engine 240, aggregate feature service 250, and/or feature store 260. For example, bootstrapper 246 may correspond to a bootstrapping operation or application that includes a self-starting or automatic process that may proceed without requiring user input, requests, or intervention that may automatically perform the processes described in system environment 200. Thus, bootstrapper 246 of data aggregation engine 240 may interface with the elements, processors, and applications in system environment 200 to automate such features for predictive data aggregation and use of such data aggregations independent of users, administrators, and the like requesting such operations for data aggregations.

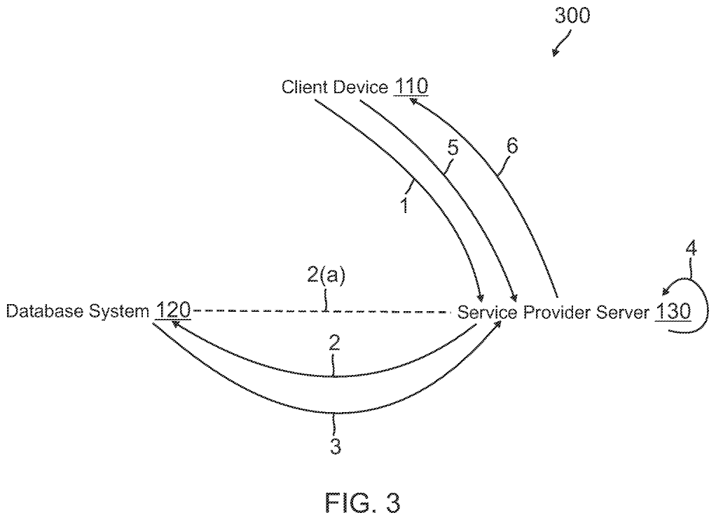

FIG. 3 is an exemplary diagram 300 of data processing interactions to determine data values to reduce latency in data retrieval and processing, according to an embodiment. Diagram 300 includes client device 110, database system 120, and service provider server 130 discussed in reference to system 100 of FIG. 1 for predictive data aggregations used in anomaly detection. In this regard, diagram 300 includes the interactions between the computing devices, servers, and databases in order to provide the services for predictive data aggregations and other predetermined data values discussed herein.

In diagram 300, client device 110 is shown as performing an interaction 1 with service provider server. Interaction 1 may correspond to an event, such as an electronic transaction processing event, requested by client device 110 to be performed by service provider server 130. However, other types of interactions and events may also be performed. This may generate data, which may have different features. For example, the features may be associated with an account, user, device, transaction, etc., from the particular event. Interaction 1 may generate feature data for the particular account, user, device, transaction, etc., from the event. In various embodiments, interaction 1 may correspond to a plurality of separate interactions and events, each of which generate data that may correspond to the feature data from the interactions and events. Thereafter, at interaction 2, service provider server 130 stores the feature data to a remote and/or offline big data storage system, database system 120. Interaction 2 may occur over time based on multiple events and interactions. For example, interaction 2a may show additional optional storages of further feature data to database system 120.

At interaction 3, service provider server 130 incrementally pulls or requests feature data from database system 120, such as for individual accounts over a time period or cycle required for predictive data aggregations. Interaction 3 may occur over a time period and include multiple pull requests of the feature data. Interaction 3 further may occur prior to the feature data being required so that the latency in performing the pulls of the feature data from database system 120 does not affect data processing and decision services of service provider server 130. Thereafter, once the feature data is pulled, service provider server 130 processes the data at interaction 4. Interaction 4 may correspond to determining data aggregations and other data values from the aggregations. The data aggregations and other data values may correspond to different features from the events and corresponding data and may further correspond to certain time periods or other amounts of time for aggregation of the corresponding feature. After determination of the data aggregations and other data values, service provider server 130 may further store these aggregations and values to a distributed computing system and resource of service provider server 130.

Thereafter, client device 110 may interact further with service provider server 130 during an event at interaction 5. The event from interaction 5 may correspond to a further use of a service and/or processing operation provided by service provider server 130 to a user of client device 110. For example, client device 110 may generate an electronic transaction processing request for a digital transaction, which may be processed using an account of the user with service provider server 130. Service provider server 130 may require an automated system to determine a decision, such as an anomaly detection, risk analysis, and/or fraud detection system of service provider server 130. During interaction 5, service provider server 130 may access the pre-calculated data aggregations and/or data values from the distributed computing system. This is done without accessing database 120 so that latency in accessing database system 120 does not affect the decision service. Using the accessed aggregation(s) and/or value(s), service provider server 130 may determine a decision, which is used during the event performed by client device 110 with service provider server 130. Thereafter, service provider server 130 provides a result to client device 110 at interaction 6. The result provided to client device 110 at interaction 6 may be based on the data processing using the data aggregation(s) and/or data values associated with client device 110. For example, the result may return some data or operations based on the event requested by client device 110.

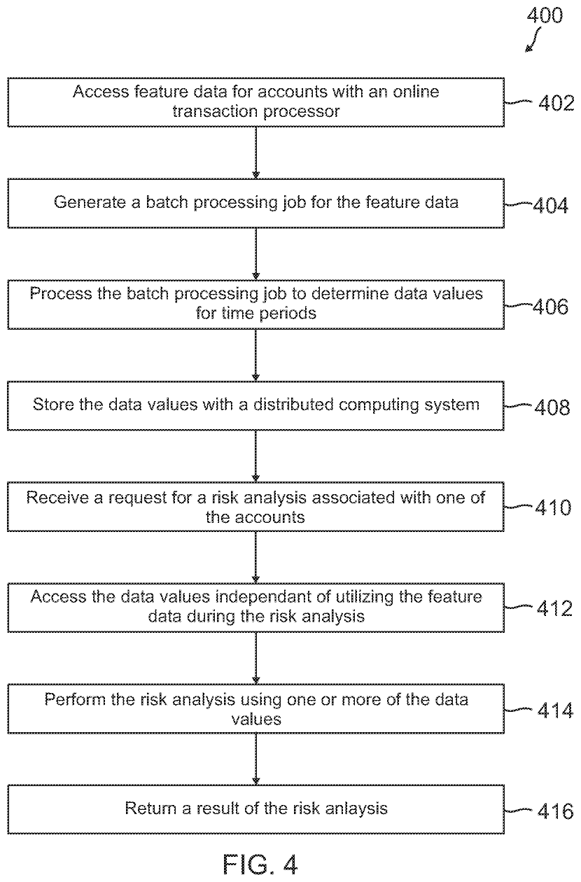

FIG. 4 is a flowchart 400 of an exemplary process for predictive data aggregations for real-time detection of anomalous data, according to an embodiment. Note that one or more steps, processes, and methods described herein of flowchart 400 may be omitted, performed in a different sequence, or combined as desired or appropriate.

At step 402 of flowchart 400, feature data for accounts with an online transaction processor is accessed. This feature data may correspond to features from accounts, users, devices, transactions, and the like, that may result from events that occur when a computing device interacts with a platform of an online service provider. Thus, the feature data may correspond to individual and collective features of data occurring from interactions between disparate devices over a network. The feature data may include the aforementioned features of a single account, as well as multiple different accounts, and may be pulled, retrieved, and/or received, incrementally over a period of time. Next, at step 404, a batch processing job for the feature data is generated. The batch processing job may correspond to individual threads of the feature data retrieval that accrues the features from the corresponding data set over a period of time and/or prior to use of such features during AI decision-making.

At step 406, the batch processing job is processed to determine data values, which may include determinations of those data values over different time periods. The batch processing job may include feature data for multiple accounts, which is preprocessed to determine different data aggregations and/or data values utilized by an intelligent decision-making system from anomaly detection, risk analysis, and the like. The batch processing job may result in different data aggregations and data values that correspond to different features of data for one or more accounts over a time period. Once determined, at step 408, the data values are stored with a distributed computing system. Storage of such data may allow the data values to be quickly accessed without having to retrieve the underlying feature data from the offline and/or remote database systems.

Thereafter during a later system event where one or more computing devices request processing of some data, a request is received for a risk analysis (or other decision service), which is associated with one of the accounts, at step 410. This risk analysis may be associated with an electronic processing request to detect anomalous data and/or data processing requests within the electronic transaction processing request. Thus, the request may require previous event data for the one or more accounts, devices, users, or the like, in order to determine whether the request may be approved, declined, or otherwise obtain additional information (e.g., to approve, decline, or the like).

At step 412, the data values are accessed independent of utilising the feature data during the risk analysis. The data values may be accessed in response to the request and may be retrieved from the distributed computing architecture. This may be done during the risk analysis from available feature data stores in order to reduce the latency required when interacting with a remote or offline database. Thereafter, at step 414, the risk analysis is performed using one or more of the data value. For example, a risk analysis model and/or engine may determine whether the request indicates anomalous behavior and/or data such that the underlying processing transaction should be approved or declined. This may include determining whether to approve or decline an electronic transaction processing request. In response to the determination of the risk analysis using one or more of the predetermined data values, a result is returned, at step 416.

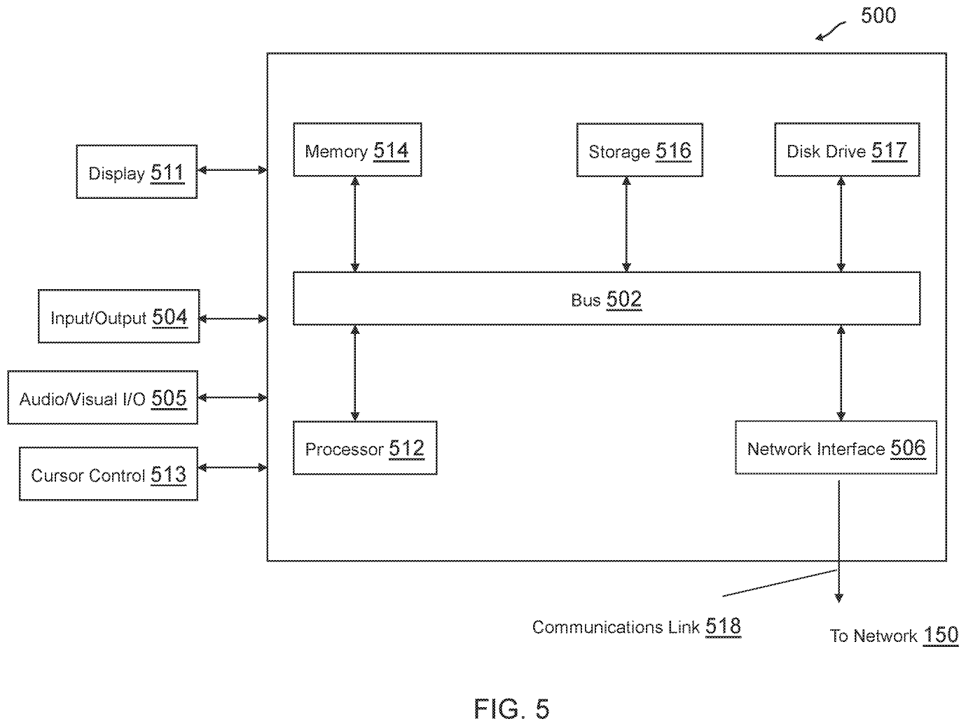

FIG. 5 is a block diagram of a computer system suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500.

In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
accessing feature data for a first account over a first time period from a distributed storage system, wherein the feature data is associated with a risk analysis system for an online transaction processor;
determining a plurality of first data values for the feature data used by the risk analysis system with one or more subsequent risk analyses associated with the first account;
storing the plurality of first data values;
receiving a first request for a first risk analysis by the risk analysis system for the first account; and
retrieving at least one of the plurality of first data values for the first risk analysis independent of further accessing the feature data from the distributed storage system at a first time of performing the first risk analysis.

2. The system of claim 1, wherein the operations further comprise:
performing the first risk analysis using the at least one of the plurality of first data values independent of further accessing the feature data from the distributed storage system at the first time; and
providing a first result of the performing the first risk analysis to the first request.

3. The system of claim 2, wherein the first request for the first risk analysis is associated with an electronic transaction processing request by the first account using the online transaction processor.

4. The system of claim 1, wherein the plurality of first data values comprise a plurality of data aggregations of account features and transaction features associated with the first account, and wherein the feature data is selected to reduce a latency of the first risk analysis when accessing the feature data from the distributed storage system.

5. The system of claim 1, wherein prior to the accessing the feature data, the operations further comprise:
determining a plurality of time periods for the plurality of first data values required by the risk analysis system for performing the first risk analysis,
wherein the first time period comprises one of the plurality of time periods.

6. The system of claim 1, wherein the plurality of first data values is stored in a database of a distributed computing system for the online transaction processor, and wherein the distributed computing system is available for a production computing environment associated with the risk analysis system.

7. The system of claim 1, wherein the feature data is further associated with a second account and over a second time period, and wherein the feature data is stored in a data cache prior to the determining the plurality of first data values.

8. The system of claim 7, wherein prior to the determining the plurality of first data values, the operations further comprise:
generating a batch processing job for the first account and the second account using the feature data,
wherein the determining the plurality of first data values uses the batch processing job.

9. The system of claim 8, wherein the operations further comprise:
determining a plurality of second data values for the feature data used by the risk analysis system when performing a second risk analysis for the second account using the batch processing job; and
storing the plurality of first data values.

10. The system of claim 9, wherein the operations further comprise:
receiving a second request for the second risk analysis by the risk analysis system for the second account;
retrieving at least one of the plurality of second data values for the second risk analysis independent of further accessing the feature data from the distributed storage system at a second time of performing the second risk analysis;
performing the second risk analysis using the at least one of the plurality of second data values independent of further accessing the feature data from the distributed storage system at the second time; and
providing a second result of the performing the second risk analysis to the second request.

11. The system of claim 1, wherein the feature data comprises at least one of a transaction feature for a transaction processed using the first account, an account feature of the first account, or a device feature for a device associated with the first account.

12. The system of claim 1, wherein the risk analysis comprises one of an authentication process for the account or an electronic transaction processing request for a transaction using the first account.

13. A method comprising:
receiving a request for an action performed using an account with a service provider platform;
retrieving predetermined data values for the account from a data storage of a distributed computing system for the service provider platform, wherein the predetermined data values are determined prior to receiving the request using account feature data for the account;
processing the request using the predetermined data values independent of accessing the account feature data during the request; and
providing a response to request based on the processing, wherein the response indicates a risk assessment of the action.

14. The method of claim 13, wherein prior to the receiving the request, the method further comprises:
receiving the account feature data for the account; and
storing the account feature data.

15. The method of claim 14, wherein prior to the receiving the request, the method further comprises:
accessing the account feature data;
generating a batch processing job using at least the account feature data;
determining the predetermined data values for the account using the batch processing job; and
storing the predetermined data values.

16. The method of claim 15, wherein the batch processing job further uses a plurality of account feature data for a plurality of accounts.

17. The method of claim 15, wherein the determining the predetermined data values comprises processing the batch processing job in an offline system environment prior to receiving the request.

18. The method of claim 13, wherein the account feature data comprises at least one of account data, an account feature, a processed transaction, a device parameter, or a device identifier, and wherein the predetermined data values comprise data aggregations for the account feature data over a plurality of time periods.

19. A non-transitory machine-readable medium having stored thereon machine-readable instructions executable to cause a machine to perform operations comprising:
receiving data features for a digital account with an online transaction processor, wherein the data features are associated with account data and transaction data for transactions processed using the digital account through the online transaction processor;
determining a batch processing job for a plurality of data features include the data features of the digital account, wherein the batch processing job determines a plurality of feature data aggregations for a plurality of digital accounts including the digital account;
determining a feature data aggregation for the digital account using the batch processing job prior to performing a risk assessment for the digital account; and
storing the feature data aggregation by a distributed computing system of the online transaction processor.

20. The non-transitory machine-readable medium of claim 19, wherein the operations further comprise:
receiving, after the storing, a request for the risk assessment for the digital account;
retrieving the feature data aggregation from the distributed computing system; and
determining the risk assessment using the feature data aggregation without processing the data features for the digital account.
